(19) United States
(12) Patent Application Publication
(10) Pub. No.: US 2007/0169010 A1
(43) Pub. Date: Jul. 19, 2007

(54) Multiplatform programming environment

(75) Inventors: Richard L. Garner, Issaquah, WA (US); Jeffrey A. Scofield, Seattle, WA (US); Balasubramanian Viswanathan, Kirkland, WA (US); Howard Jess, Mercer Island, WA (US); Son Nguyen, Shoreline, WA (US)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(73) Assignee: DHI Technologies, Inc., Renton, WA (US)

(21) Appl. No.: 11/263,134

(22) Filed: Oct. 31, 2005

(51) Int. Cl. G06F 9/45

(52) U.S. Cl. 717/136

(57) ABSTRACT

A multiplatform programming environment enables development of correct and reliable programs for heterogeneous computing environments. A set of features and/or functionality that is independent of a particular programmatic platform may be specified with one or more domain specifications, and multiplatform programs may be developed in accordance with the domain specification(s). Domain specification compliance tools may analyze source code, including source code containing statements of interpreted and/or weakly typed programming languages, in order to identify and report specification non-compliance. The source code may be translated into multiplatform code. Execution of the multiplatform code may be requested by a particular platform. Platform capabilities may be assessed and augmented as required to conform to a multiplatform standard, for example, corresponding to the domain specification, and the multiplatform code may be executed by the assessed platform.

### FIELD OF THE INVENTION

This invention pertains generally to computing and, more particularly, to computer programming.

### BACKGROUND OF THE INVENTION

Modern computing environments can be complex heterogeneities. Computer networking technologies have meant that it is not uncommon for computing environments to include several types of computer, each having a different hardware and/or software configuration. From fiber-optic linked supercomputers and commodity personal computers (PCs) to wireless personal digital assistants (PDAs) and dedicated-purpose computers, the variety and versions of hardware components, component resources, operating systems, software components and the protocols through which they interact can be a challenge to manage and, in particular, to program.

There have been attempts at standardization by individual vendors and consortia. Particular sets of hardware and/or software configurations are designated as programmatic platforms that provide minimum sets of features and functionality upon which to build. Examples include the Microsoft® Windows® programmatic platform, The Open Group UNIX® programmatic platform, and Sun Microsystems Java™ programmatic platform. Nonetheless, competitive pressures and the constant introduction of new features have typically worked to maintain, if not enhance, heterogeneity. Some individual vendors even support multiple programmatic platforms, and different versions of what is nominally a single platform may, in practice, be treated as separate platforms by computer programmers. For example, the 16-bit and 32-bit versions of the Microsoft® Windows® programmatic platform are commonly treated as separate platforms by computer programmers.

Such programmatic platforms are commonly presented as monolithic and independent, and typically lack fine-grained feature and functionality selection abilities catering to multiplatform programmers such as an ability to require that aspects of one platform comply with aspects of another platform. As a result, developing separate versions of a computing application for different programmatic platforms can require significant effort. Providing an application version for each possible programmatic platform that may be a part of a given computing environment can quickly become cost prohibitive, particularly if the computing environment includes a public internet or other large computer network.

A common response to the challenge by computer programming teams has been to develop the computing application for only a single programmatic platform or some small subset of computing environment platforms. This response is rarely optimal since, for example, it can result in a reduced application user base, and may be outright unacceptable for some applications. Another response has been to simply omit functionality and/or program for the lowest common denominator programmatic platform. Again, this response can be less than satisfactory, for example, because of degraded application functionality.

Previous attempts at facilitating multiplatform programming have included installation of various clients, from lightweight markup language browsers to heavyweight virtual machines, at computers of the computing environment. However, in many cases each type of client has itself become a programmatic platform and subject to competitive and/or innovative speciation. Conventional attempts to solve the problem of multiplatform programming have failed to provide an ability to develop correct and reliable multiplatform programs that are also able to respond flexibly to changing functional requirements and a changing heterogeneous computing environment. For example, inability to effectively compensate for updates to particular platforms in a set of target platforms can cause incorrect or unreliable functioning and/or be a source of inflexibility when modifying the computing application.

### BRIEF SUMMARY OF THE INVENTION

This section presents a simplified summary of some embodiments of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In an embodiment of the invention, one or more domain specifications are selected, for example, by a user of a multiplatform development environment. The domain specifications may correspond to a multiplatform development standard. One or more source code units may be selected. For example, the source code units may be files containing statements of a computer programming language. The source code units may be translated into corresponding multiplatform code units. The translation may occur in accordance with the domain specifications.

In an embodiment of the invention, a set of multiplatform objects to be linked is specified, for example, by a user of the multiplatform object linker. The multiplatform object linker may be type-aware. Type consistency may be checked across the set of multiplatform objects and, if the set of multiplatform objects is type consistent, then each multiplatform object in the set of multiplatform objects may be linked. For example, a deployment package in accordance with the domain specifications may include linked multiplatform objects.

In an embodiment of the invention, a platform is augmented to meet a multiplatform standard. One or more capabilities assessment components may be loaded, for example, by the platform to be augmented. An assessed capabilities record may be generated for the platform. Some or all of the assessed capabilities record may be generated by the capabilities assessment components. One or more multiplatform components providing augmentation functionality may be loaded, for example, by the platform. The multiplatform components may be loaded in accordance with the assessed capabilities record.

### BRIEF DESCRIPTION OF THE SEVERAL VIEWS OF THE DRAWING(S)

While the appended claims set forth the features of the invention with particularity, the invention and its advantages are best understood from the following detailed description taken in conjunction with the accompanying several views of the drawing(s), of which:

FIG. 1 is a schematic diagram illustrating an example computing environment suitable for incorporating and/or implementing an embodiment of the invention;

FIG. 2 is a schematic diagram illustrating an example networked computing environment suitable for incorporating an embodiment of the invention;

FIG. 3 is a schematic diagram illustrating an example multiplatform programming environment in accordance with an embodiment of the invention;

FIG. 4 is a schematic diagram illustrating an example multiplatform code development environment in accordance with an embodiment of the invention;

FIG. 5 is a block diagram depicting an example multiplatform component library in accordance with an embodiment of the invention;

FIG. 6 is a schematic diagram illustrating a server and client exchanging multiplatform messages in accordance with an embodiment of the invention;

FIG. 7 is a flowchart depicting example steps for executing multiplatform code in accordance with an embodiment of the invention;

FIG. 8 is a flowchart depicting example steps for developing multiplatform code in accordance with an embodiment of the invention;

FIG. 9 is a flowchart depicting further example steps for developing multiplatform code in accordance with an embodiment of the invention;

FIG. 10 is a flowchart depicting example steps for translating to multiplatform code in accordance with an embodiment of the invention;

FIG. 11 is a flowchart depicting example steps for linking multiplatform objects in accordance with an embodiment of the invention;

FIG. 12 is a flowchart depicting further example steps for linking multiplatform objects in accordance with an embodiment of the invention;

FIG. 13 is a flowchart depicting example steps for single point of entry platform augmentation in accordance with an embodiment of the invention;

FIG. 14 is a flowchart depicting example steps performed by a multiplatform constructor in accordance with an embodiment of the invention; and

FIG. 15 is a flowchart depicting example steps for selective augmentation in accordance with an embodiment of the invention.

### DETAILED DESCRIPTION OF THE INVENTION

In an embodiment of the invention, a multiplatform programming environment enables development of correct and reliable programs for heterogeneous computing environments. A set of features and/or functionality that is independent of a particular programmatic platform may be specified with one or more domain specifications, and multiplatform programs may be developed in accordance with the domain specification(s). Domain specification compliance tools may analyze source code, including source code containing statements of interpreted and/or weakly typed programming languages, in order to identify and report specification non-compliance. The source code may be translated into multiplatform code. Execution of the multiplatform code may be requested by a particular platform. Platform capabilities may be assessed and augmented as required to conform to a multiplatform standard, for example, corresponding to the domain specification, and the multiplatform code may be executed by the assessed platform.

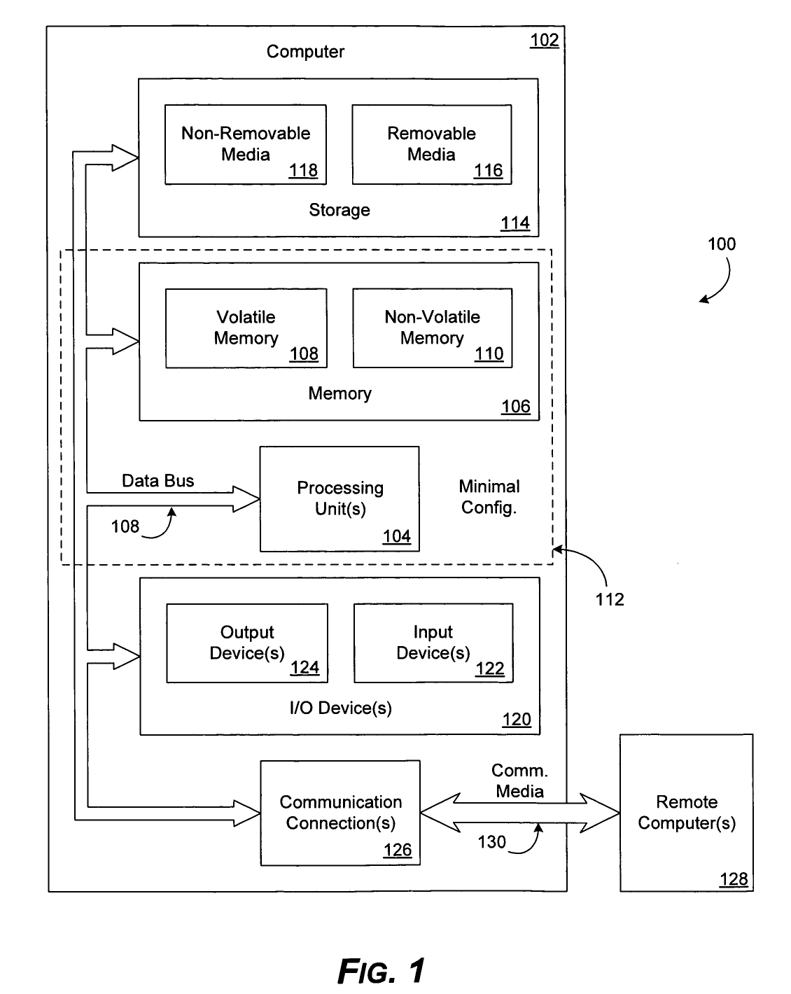

Before describing embodiments of the invention in more detail, it will be helpful to provide context and details with respect to computing environments suitable for incorporating and/or implementing embodiments of the invention. FIG. 1 illustrates an example of a suitable computing environment 100. The computing environment 100 may include a computer 102 having one or more processing units 104 and memory 106 connected by a data bus 108.

Each processing unit 104 may execute instructions to perform tasks in accordance with an embodiment of the invention. Each processing unit 104 may send and/or receive signals, for example, over the data bus 108. Each processing unit 104 may transform and/or generate signals, for example, in the course of executing instructions. In an embodiment of the invention, such signals are electronic signals representing digital data. However, each embodiment of the invention is not so limited. For example, data may be analog in nature, and signals may be encoded and/or transformed with any suitable physical phenomena including those associated with mechanics and optics.

The memory 106 may maintain data in addressable locations and provide the data to other components of the computer 102, for example, over the data bus 108. The memory 106 may include volatile memory 108 such as suitable random access memory (RAM), dynamic RAM (DRAM) and synchronous DRAM (SDRAM), and/or non-volatile memory 110 such as suitable read-only memory (ROM), erasable programmable ROM (EPROM), electrically-erasable programmable ROM (EEPROM) and flash memory. Processing unit(s) 104 may physically incorporate memory such as memory 106 (e.g., include cache memory).

The memory 106 may store one or more computer programs and/or computer program components. Each computer program and/or program component may include instructions executable by the processing unit(s) 104 and/or structured or unstructured data. Each computer program and/or program component may include modules, routines and/or any suitable programmatic object to organize the instructions and/or data. Each computer program and/or program component may include and/or correspond to elements of one or more computer programming languages. Any suitable computer programming language may be utilized to create computer programs and/or program components including, without limitation, machine and assembly languages, procedural programming languages, imperative programming languages, functional programming languages, object-oriented programming languages, interpreted programming languages, complied programming languages and combinations thereof.

The dashed line 112 delineates a minimal configuration of the computer 102. The computer 102 may further include storage 114 connected to the memory 106 and/or processing unit(s) 104 by the data bus 108. The storage 114 may include removable 116 and non-removable 118 media. The storage 114 may include any suitable computer-readable media including, without limitation, magnetic media such as hard disks, floppy disks and tapes, optical media such as compact disks (CD) and digital versatile disks (DVD), volatile and non-volatile media such as RAM, ROM and flash memory, and combinations thereof. The storage 114 may store any suitable data. Transfer of data to and from the storage 114, for example, to the memory 106, may require processing by the processing unit(s) 104.

The computer 102 may further include one or more input/output (I/O) devices 120 capable of capturing and providing data to and from the computer 102. The I/O devices 120 may include any suitable input device(s) 122 such as keyboards, keypads, mice, touchpads, trackballs, pens, joysticks, gamepads, scanners, webcams, microphones, and associated device interface hardware. The I/O devices 120 may include any suitable output device(s) 124 such as monitors, liquid crystal displays (LCD), light emitting diodes (LED), printers, speakers, and associated device interface hardware. Transfer of data to and from the I/O devices 120, for example, from and to the memory 106, may require processing by the processing unit(s) 104.

The computer 102 may further include one or more communication connections 126 providing, or capable of providing, communication with one or more remote computers 128 in the computing environment 100 over suitable communication media 130. For example, the communication connection(s) 126 may be maintained with I/O devices 120 such as modems or network interface hardware. Communication media 130 may include any suitable wired communication media such as copper wire, coaxial cable and optical fiber, as well as any suitable wireless communication media such as electromagnetic media including radio, microwave, infra-red and laser. Data, for example, from the memory 106, may be encoded and transmitted over the communication media with any suitable communication technology and/or protocol. The storage 114, the communication connection(s) 126 and the communication media 180 are each examples of computer-readable media.

When the computer 102 and remote computer(s) 128 are linked by communication connection(s) 126, programs and/or program components may be distributed among the memory 106 and/or storage 114 of both the local 102 and remote 128 computers. Furthermore, in such a distributed computing environment, program and/or program component instructions may be executed by the processing unit(s) 104 of both the local 102 and remote 128 computers. Each computer 102, 128 may be, or be incorporated by, any suitable type of computer or computing device including, without limitation, a personal computer (PC), a desktop computer, a laptop computer, a tablet computer, a personal digital assistant (PDA), a workstation, a minicomputer, a server, a mainframe, a router, a gateway, a switch, a hub, a mobile phone and a programmable consumer electronics device or other embedded computer.

For clarity, embodiments of the invention may be described with reference to symbolic operations and manipulations of structured data in a suitable computer programming language. As described above, such operations, manipulations and structures correspond to physical states of components and changes in components of computers such as the computers 102, 128 in a manner well understood by one of skill in the art. Furthermore, in an embodiment of the invention, each such operation, manipulation and/or structure may be fully implemented in hardware.

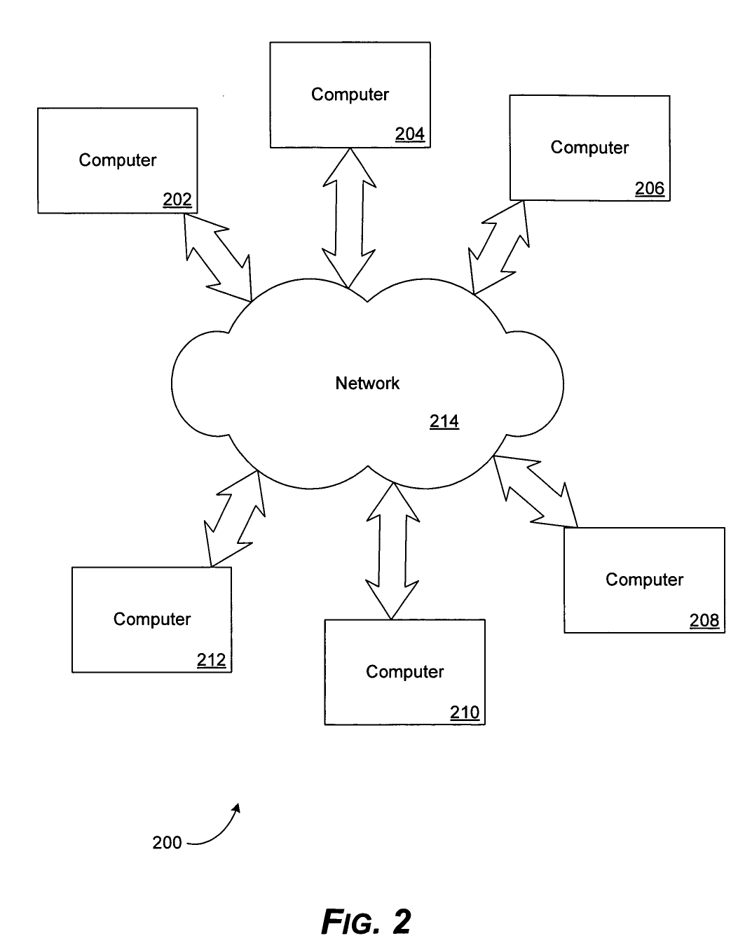

FIG. 2 illustrates an example networked computing environment 200 suitable for incorporating embodiments of the invention. The networked computing environment 200 includes computers 202, 204, 206, 208, 210 and 212 connected by a network 214. Each of the computers 202, 204, 206, 208, 210 and 212 may incorporate some or all of the features of the computer 102 (FIG. 1). In particular, each of the computers 202, 204, 206, 208, 210 and 212 may include a particular communication connection 126 to the network 214. In an embodiment of the invention, the network 214 enables each of the computers 202, 204, 206, 208, 210 and 212 to communicate with any of the other computers 202, 204, 206, 208, 210 and 212. Each of the computers 202, 204, 206, 208, 210 and 212 may act as one or more of a client, a server or a peer to each of the other computers 202, 204, 206, 208, 210 and 212. The network 214 may include one or more hubs, switches, routers, gateways or any suitable computer 102. The networked computing environment 200 may support a distributed computing environment.

Although the variety of heterogeneous computing environments is large, representative aspects of their interaction with a multiplatform programming environment may be ascertained from consideration of a heterogeneous computing environment incorporating a client-server architecture. For clarity then, the description that follows will at times make reference to servers and clients and even to particular types of servers and clients familiar to those of skill in the art such as servers and clients that participate in web services. However, each embodiment of the invention is not so limited, and heterogeneous computing environments in accordance with an embodiment of the invention may include any suitable interactive architecture including n-tier, peer-to-peer, publish-subscribe, and broadcast.

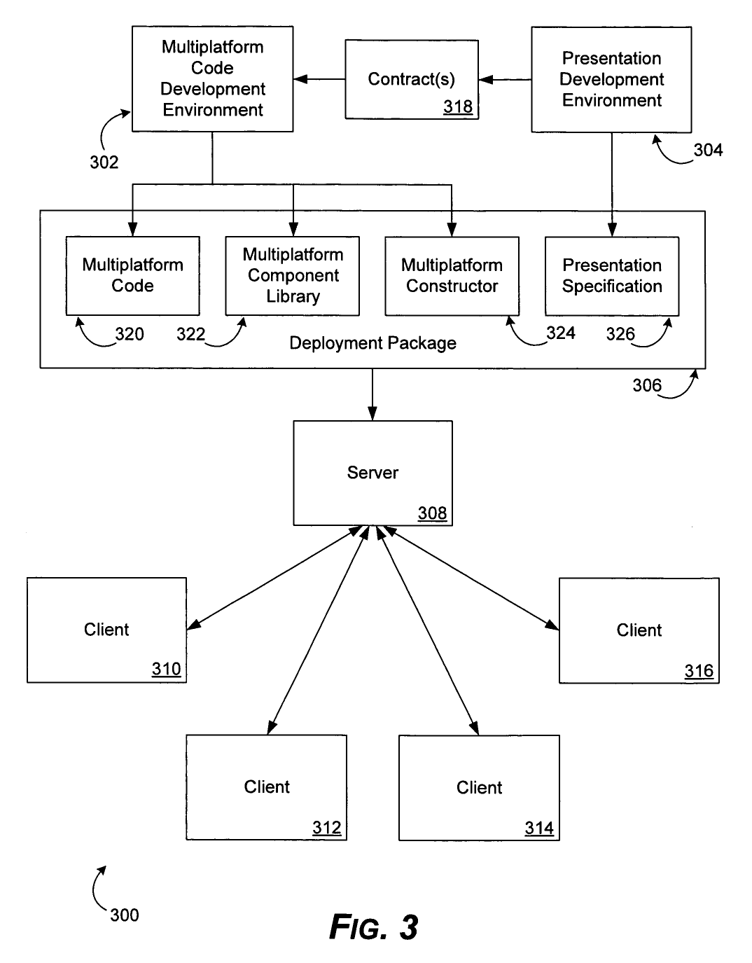

FIG. 3 depicts an example multiplatform programming environment 300 incorporating a client-server architecture in accordance with an embodiment of the invention. The multiplatform programming environment 300 may include a multiplatform code development environment 302 and a presentation development environment 304. Together, the multiplatform code development environment 302 and the presentation development environment 304 may produce a deployment package 306. The deployment package 306 may be deployed to a server 308. The server 308 may utilize the deployment package 306 to respond to requests by clients 310, 312, 314 and 316. Each client 310, 312, 314 and 316 may correspond to a different programmatic platform.

In developing applications for multiple programmatic platforms, it may be the case that application presentation aspects can be developed somewhat independently from application behavior aspects. Of course, the two may interact, but different skill sets tend to separate application presentation developers from application behavior developers and each group may utilize a different (if overlapping) set of tools corresponding to the presentation development environment 304 and the multiplatform code development environment 302 respectively. In an embodiment of the invention, such division of labor is facilitated with a programmatic contract 318 that specifies to the multiplatform code development environment 302 relationships, such as points of interaction, between presentation aspects and behavior aspects of the application.

The multiplatform code development environment 302 may provide multiplatform code 320, multiplatform component library 322, and multiplatform constructor 324 elements of the deployment package 306. The presentation development environment 304 may provide a presentation specification 326 element of the deployment package 306. The multiplatform constructor 324 may be a point of first reference by the client 310, 312, 314, 316 and have reference to the multiplatform code 320, the multiplatform component library 322 and the presentation specification 326. Alternatively, the presentation specification 326 may be the point of first reference for the application, and the presentation specification 326 may have reference to the multiplatform constructor 324, with the multiplatform constructor 324 further referencing the multiplatform code 320 and the multiplatform component library 322.

For example, the server 308 may include a markup language protocol server such as a hypertext transfer protocol (HTTP) server, and the clients 310, 312, 314 and 316 may each include a markup language client such as a hypertext browser. The presentation specification 326 may include a markup language such as hypertext markup language (HTML), and the multiplatform code 320 may include a client scripting language such as a scripting language corresponding to the ECMAScript programming language as described by the “ECMAScript Language Specification,” ECMA-262, 3^{rd} edition, ECMA International, December 1999.

As will be appreciated by one of skill in the art, this is not a limiting example. The presentation specification 326 may include any suitable presentation specification mechanism including further document specification languages such as portable document format (PDF), rich text format (RTF), and extensible markup language (XML), as well as Macromedia Shockwave™ Flash™ (SWF) files, Microsoft® Windows® resource (RC) files, Microsoft®.NET resource (RESX) files and any suitable programming language source and/or object code. Furthermore, the multiplatform code 320 may include any suitable programming language source and/or object code including further scripting languages such as Tool Command Language (Tcl), Practical Extraction and Report Language (Perl), Python and Ruby, as well as C, C++, Java™, Microsoft® Visual C#®, Microsoft® Visual Basic® and any suitable compiled and/or interpreted programming language. However, for clarity, particulars of this example may be assumed in continuing examples below.

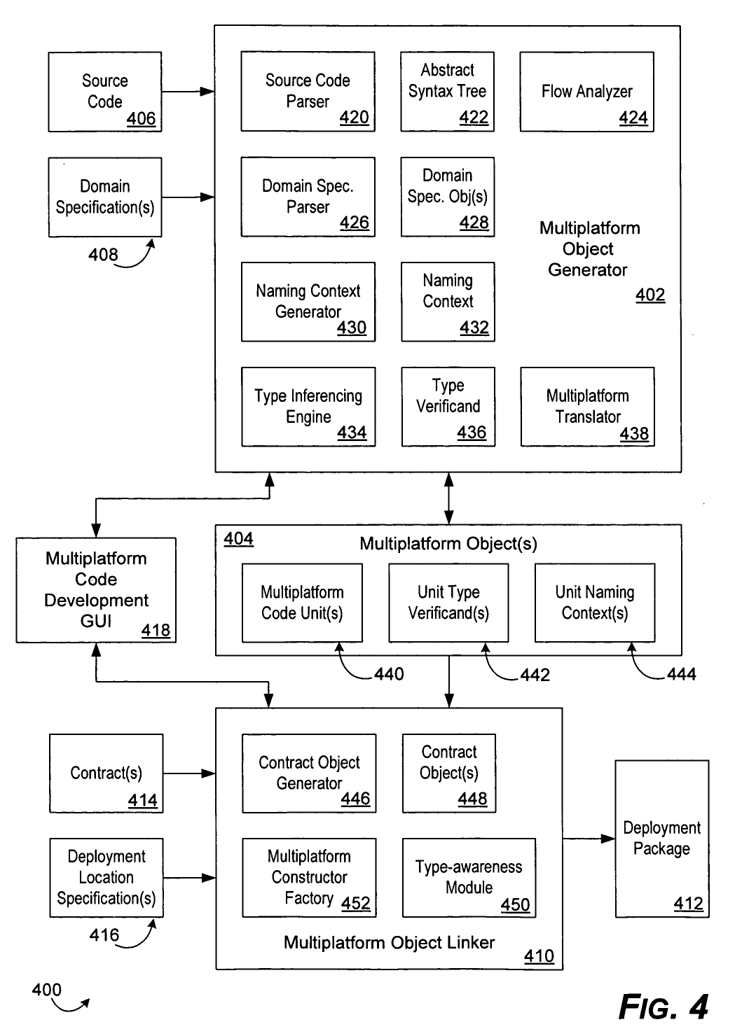

Before describing example procedures performed by the multiplatform programming environment 300 in accordance with an embodiment of the invention, it will be helpful to describe elements of the multiplatform programming environment 300 in more detail. FIG. 4 depicts an example multiplatform code development environment 400 in accordance with an embodiment of the invention. For example, the multiplatform code development environment 400 may serve as the multiplatform code development environment 302 described above with reference to FIG. 3.

The multiplatform code development environment 400 may include a multiplatform object generator 402 for generating one or more multiplatform objects 404 from source code 406 and one or more domain specifications 408. A multiplatform object linker 410 may package the multiplatform object(s) 404 into a deployment package 412 in accordance with one or more contracts 414 and one or more deployment location specifications 416. The deployment package 412 and the contract(s) 414 may correspond to the deployment package 306 and contract(s) 318 of FIG. 3. The multiplatform object generator 402 and the multiplatform object linker 410 may be controlled by, and provide information to, a multiplatform code development graphical user interface (GUI) 418. In particular, the multiplatform object generator 402 and the multiplatform object linker 410 may provide information with respect to source code 406 anomalies and inconsistencies as well as compliance with the domain specification(s) 408.

The arrows connecting diagrammatic elements 402, 404, 406, 408, 410, 412, 414, 416 and 418 of FIG. 4 indicate predominate direction(s) of flow of data and/or inter-module commands. In an embodiment of the invention, data and/or commands need not propagate in a reverse direction, however, each embodiment of the invention is not so limited. Data and/or commands may propagate in a reverse direction, for example, to provide status information and/or to improve processing efficiency.

The multiplatform object generator 402 may include a source code parser 420 capable of parsing the source code 406 and creating a corresponding abstract syntax tree (AST) 422. The source code 406 may include statements of any suitable programming language organized into one or more source code units. The source code 406 may specify structure and/or behavior of the computing application. For example, the source code 406 may contain statements of the ECMAScript programming language and the source code parser 420 may be largely generated with conventional lexical analyzer generators and parser compilers (e.g., lex and yacc).

The multiplatform object generator 402 may further include a programmatic flow analyzer 424. The flow analyzer 424 may correspond to a conventional computer program flow analyzer, and may analyze the abstract syntax tree 422 to identify execution flow anomalies. For example, the flow analyzer 424 may identify dead code, that is, blocks of programming language statements in the source code 406 that can not be executed at runtime due to a current structure of the computer program specified by the source code 406.

Each domain specification 408 may include statements of any suitable programming language and/or statements of any suitable markup language, or suitable subset thereof. The multiplatform object generator 402 may further include a domain specification parser 426 capable of parsing the domain specification(s) 408. The domain specification parser 426 may create and/or update one or more domain specification objects 428 corresponding to the domain specification(s) 408. In an embodiment of the invention, each domain specification 408 corresponds to a domain specification as described in copending, commonly assigned, U.S. patent application Ser. No. ______, attorney docket No. 306889, file herewith, entitled “INCREMENTAL TYPE INFERENCING ENGINE.”

The multiplatform object generator 402 may further include a naming context generator 430. The naming context generator 430 may analyze the abstract syntax tree 422 and/or the domain specification object(s) 428 to create and/or update a corresponding naming context 432 that includes programmatic identifiers associated with one or more lexical scoping contexts. For example, a particular variable may be associated with one or more of a set of nested lexical scopes. Since lexical scoping contexts may be nested, the naming context 432 may have a structure corresponding to a tree. Programming languages typically require identifiers to be unique only within a particular lexical scope. The naming context 432 may enable detection of ambiguities associated with a particular set of lexical scopes.

The multiplatform object generator 402 may further include a type inferencing engine 434. The type inferencing engine 434 may create and/or update a programmatic type verificand 436 from the abstract syntax tree 422, the domain specification object(s) 428 and/or the naming context 432. The type verificand 436 may include one or more constraints corresponding to relationships between programmatic types of source code 406 and/or domain specification 408 entities. The type inferencing engine 434 may resolve the type verificand 436 to infer programmatic types, for example, types of source code 406 entities. The type inferencing engine 434 may incorporate a conventional type inference mechanism such as Hindley-Milner type inference. However, in an embodiment of the invention, the type inferencing engine 434 is an incremental type inferencing engine as described in copending, commonly assigned, U.S. patent application Ser. No.______, attorney docket No. 306889, file herewith, entitled “INCREMENTAL TYPE INFERENCING ENGINE,” and, as a result, may infer programmatic types for a wider variety of programming languages, including, for example, ECMAScript.

During processing, each of the source code parser 420, the flow analyzer 424, the naming context generator 430, and the type inference engine 434 may provide source code anomaly reports, for example, to the multiplatform code development GUI 418. For example, the source code parser 420 may report syntax errors and ambiguities, the flow analyzer 424 may report dead code and execution flow ambiguities, the naming context generator 430 may report scoping ambiguities, and the type inferencing engine 434 may report type mismatches (e.g., assignment of variables with incompatible types) and ambiguities. Each anomaly report entry may be associated with one or more source code 406 locations.

Any suitable integrated development environment (IDE) GUI may be incorporated into the multiplatform code development environment 400. Illustrative examples of conventional IDE GUI including elements capable of being incorporated in the multiplatform code development environment 400 include Microsoft® Visual Studio®, Borland® Developer Studio, Apple® Xcode®, Metrowerks® CodeWarrior®, and GNU® Emacs. In an embodiment of the invention, the multiplatform code development GUI 418 corresponds to the Eclipse IDE GUI as described in the “Eclipse Platform Technical Overview,” by Object Technology International, February 2003.

The multiplatform object generator 402 may further include a multiplatform translator 438. The multiplatform translator 438 may translate source code 406 into multiplatform code suitable for the deployment package 412. The multiplatform object(s) 404 may include one or more multiplatform code units 440 generated by the multiplatform translator 438. Each multiplatform code unit 440 may correspond to a particular source code 406 unit.

The multiplatform object(s) 404 may further include one or more unit type verificands 442. Each unit type verificand 442 may correspond to a particular multiplatform code unit 440. Each unit type verificand 442 may include some or all of the type verificand 436 resolved during generation of its corresponding multiplatform code unit 440. In an embodiment of the invention, the type verificand 436 includes information required for a comprehensive audit of type relationships, whereas each unit type verificand 442 includes a reduced set of information required for inter-unit type relationship checking.

The multiplatform object(s) 404 may further include one or more unit naming contexts 444. Each unit naming context 444 may correspond to a particular multiplatform code unit 440. Each unit naming context 444 may include some or all of the naming context 432 resulting from the generation of its corresponding multiplatform code unit 440. In an embodiment of the invention, the naming context 432 includes information required for a comprehensive audit of scoping ambiguities, whereas each unit naming context 444 includes a reduced set of information required for inter-unit scope ambiguity detection, for example, those elements of the naming context 432 in a global scope.

Each contract 414 may include statements of any suitable programming language and/or statements of any suitable markup language, or suitable subset thereof. In an embodiment of the invention, the contract(s) 414 include HTML elements and ECMAScript statements. A simplified example will help illustrate:

<contract>

<form id=“myForm” onSubmit=“return validate( );”>
</form>

</contract>

Contract delimiters enclose an HTML form element. The form element specifies a particular identifier ‘myForm’ and a particular ECMAScript statement “return validate();” to be executed when a particular user interface event ‘submit’ occurs.

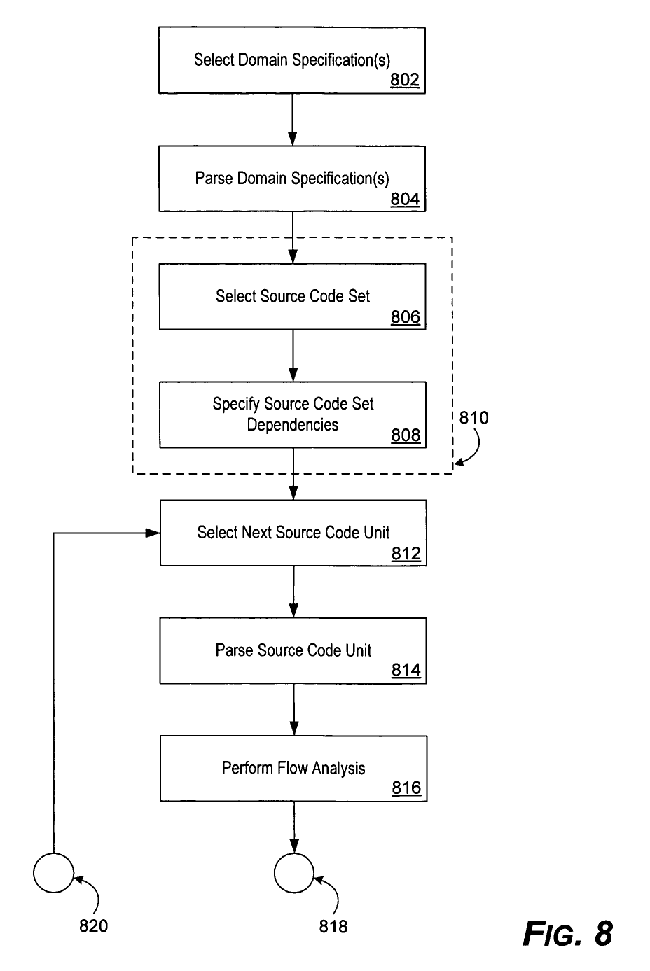

The multiplatform object linker 410 may include a contract object generator 446 capable of generating one or more contract object(s) 448 from the contract(s) 414. For example, the contract object(s) 448 may correspond to the multiplatform object(s) 404. The contract object(s) 448 may be generated by the contract object generator 446 in a manner similar to that described below for multiplatform objects 404 with reference to FIGS. 8, 9 and 10. For example, each contract object 448 may include a unit type verificand and unit naming context corresponding to ECMAScript statements in the contract(s) 414. However, in an embodiment of the invention, the contract(s) 414 specify programming language statements that may not be translated, so that, any detected translation candidates are instead reported, for example, to the multiplatform code development GUI 418. Furthermore, some contract identifiers, such as ‘myForm’ in the above example, may be treated as reserved by the multiplatform object generator 402 and/or the multiplatform object linker 410, and any duplicates found at a global scope of a naming context, such as the naming context 432 and/or the unit naming context(s) 444, may be treated as an identifier conflict.

The multiplatform object linker 410 may further include a type-awareness module 450 capable of verifying inter-unit type consistency. The type-awareness module 450 may verify inter-unit type consistency by resolving the unit type verificand(s) 442 and the contract object(s) 448, for example, in a manner corresponding to that of the type inferencing engine 434.

The multiplatform object linker 410 may further include a multiplatform constructor factory 452. The multiplatform constructor factory 452 may create multiplatform constructors suitable for the deployment package 412, such as the multiplatform constructor 324 (FIG. 3). The multiplatform constructor factory 452 may create multiplatform constructors in accordance with the contract(s) 414 and the deployment location specification(s) 416. For example, the deployment location specification(s) 416 may include one or more uniform resource names (URN) and/or uniform resource locators (URL) specifying networked computing environment 200 (FIG. 2) deployment locations. The multiplatform object linker 410 may add multiplatform constructor(s) created by the multiplatform constructor factory 452 to the deployment package 412.

In an embodiment of the invention, the contract object generator 446, contract object(s) 448, and the multiplatform constructor factory 452 are each independent of the multiplatform object linker 410. The contract object(s) 448 may be accessed by the multiplatform object linker 410 in a manner similar to the multiplatform object(s) 404. In addition, the multiplatform object generator 402 may load the contract object(s) 448 as described below for the multiplatform object(s) 404 with reference to FIG. 8. Loading of contract object(s) 448 may enhance anomaly auditing and/or translation. The contract object(s) 448 may further include information for the multiplatform constructor factory 452. In an embodiment of the invention, the contract object(s) 448 includes a list of multiplatform object(s) 404 that need not be loaded by a corresponding multiplatform constructor since it is expected that they will be loaded independently.

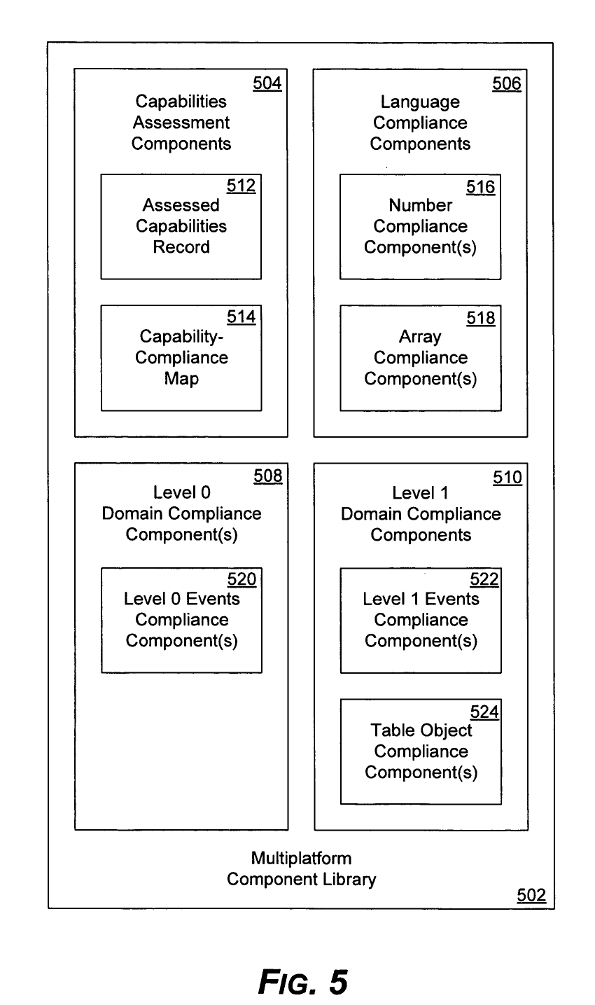

The multiplatform code unit(s) 440 generated by the multiplatform translator 438 may reference components in a multiplatform component library such as the multiplatform component library 322 (FIG. 3). The multiplatform object linker 410 may select a particular multiplatform component library corresponding to the source code 406 programming language(s) and/or the domain specification(s) 408 and add it to the deployment package 412. FIG. 5 depicts an example multiplatform component library 502 in accordance with an embodiment of the invention. The multiplatform component library 502 may include a set of capabilities assessment components 504, a set of language compliance components 506, and one or more sets of domain compliance components 508, 510.

Different programmatic platforms may have different capabilities, for example, capabilities with respect to functionality required by the domain specification(s) 408 (FIG. 4). The set of capabilities assessment components 504 may include one or more programmatic components that provide functionality for assessing platform capabilities. For example, some capabilities assessment components 504 may check for a presence or non-presence of a particular platform object or behavior. Some capabilities assessment components 504 may distinguish between different versions of a particular platform object. Some capabilities assessment components 504 may attempt to identify a particular platform, for example, with platform object behavior fingerprinting. However, in an embodiment of the invention, lifetime, reliability and/or effectiveness of the multiplatform component library is increased by minimizing a utilization of platform identification for capabilities assessment.

Capabilities assessment results may be recorded in an assessed capabilities record 512. For example, the assessed capabilities record 512 may include one or more Boolean flags, each corresponding to a particular capabilities assessment result. In addition, the assessed capabilities record 512 may include more complex data structures, for example, structures that record capabilities assessment details. Each capabilities assessment may require computational resources. In an embodiment of the invention, recording capabilities assessment results in the assessed capabilities record 512 may reduce resource utilization by minimizing a need for capabilities re-assessment.

A particular platform may require augmentation, for example, to comply with the domain specification(s) 408 (FIG. 4). Components of the multiplatform component library 502 such as the language compliance components 506 and/or the domain compliance components 508, 510 may provide the required augmentation functionality. Each assessed capability may be associated with one or more components of the multiplatform component library 502. For example, a particular capability assessed as absent from a particular platform may require one or more components of the multiplatform component library 502 to provide the capability. A capability-compliance map 514 may map capability assessments to components of the multiplatform component library 502.

Different platforms may implement features of a particular programming language differently. For example, clients 310 and 312 (FIG. 3) may implement functionality associated with the ECMAScript Number object differently, and clients 310 and 314 may implement functionality associated with the ECMAScript Array object differently. The domain specification(s) 408 (FIG. 4) may specify and/or reference particular ECMAScript Number and Array object structure and/or behavior. One or more of the clients 310, 312 and 314 may be compliant or non-compliant with respect to the ECMAScript Number and/or Array objects. The language compliance components 506 may include a set of Number compliance components 516 and a set of Array compliance components 518. The Number compliance components 516 and the Array compliance components 518 may provide the functionality required to bring each client 310, 312 and 314 into compliance with the domain specification(s) 408.

Similarly, different platforms may differently implement domain structures and/or behavior specified and/or referenced by the domain specification(s) 408 (FIG. 4). For example, clients 314 and 316 (FIG. 3) may implement domain Events behavior differently, and clients 312 and 316 may implement domain Table objects differently. One or more of the clients 312, 314 and 316 may be compliant or non-compliant with respect to domain Events and/or Table objects. Furthermore, client 312, 314, 316 compliance may be graded into one or more compliance levels, so that, for example, the client 316 may be compliant with respect to domain Events at a level 0, and the client 314 may be compliant with respect to domain Events at a level 1.

The domain compliance components 508, 510 may include a set of level 0 domain compliance components 508 and a set of level 1 domain compliance components 510. The level 0 compliance components 508 may include a set of level 0 Events compliance components 520. The level 1 compliance components 510 may include a set of level 1 Events compliance components 522, and a set of Table object compliance components 524. The level 0 Events compliance components 520 may provide the functionality required to bring each client 312, 314 and 316 into compliance with the level 0 compliance level for domain Events. The level 1 Events compliance components 522 and the level 1 Table object compliance components 524 may provide the functionality required to bring each client 312, 314 and 316 into compliance with the level 1 compliance level for domain Events and Table objects with respect to the domain specification(s) 408. In an embodiment of the invention, at least some of the structure and/or behavior provided by the level 1 domain compliance components 510 corresponds to structure and/or behavior specified by the “Domain Object Model (DOM) Level 1 Specification,” REC-DOM-Level-1-19981001, W3C Recommendation, October 1998.

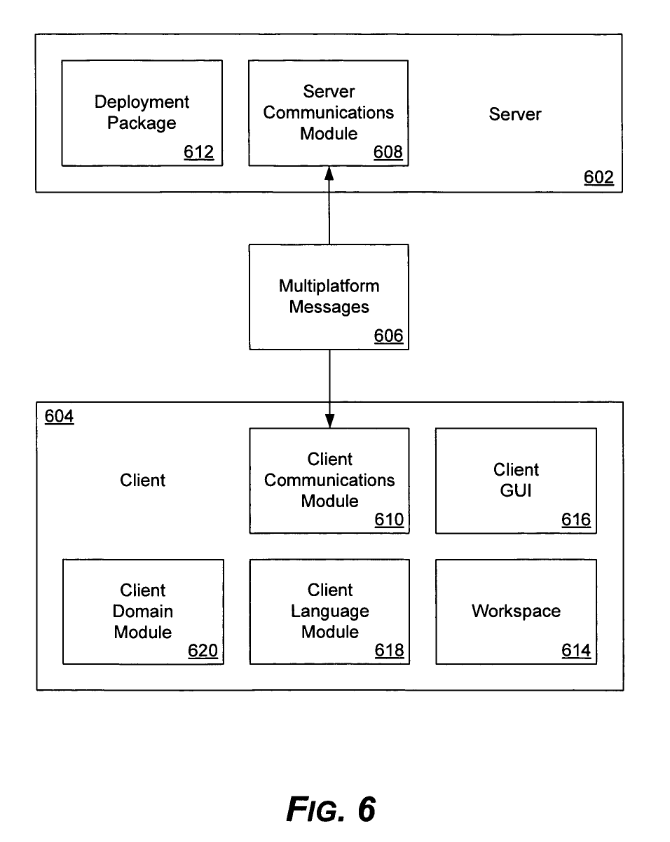

Further details with respect to the server 308 (FIG. 3) and clients 310, 312, 314 and 316 will be helpful for describing procedures performed in accordance with an embodiment of the invention. FIG. 6 depicts a server 602 and a client 604 capable of exchanging multiplatform messages 606. The server 602 may correspond to the server 308 of FIG. 3, and the client 604 may correspond to one of the clients 310, 312, 314 or 316.

The server 602 may include a server communications module 608, and the client 604 may include a client communications module 610 to send, receive, format and parse the multiplatform messages 606. The server communications module 608 and the client communications module 610 may exchange messages in addition to the multiplatform messages 606 although, for clarity, those additional messages are not shown in FIG. 6. The server 602 may include a deployment package 612 corresponding to the deployment package 306 of FIG. 3. Some or all of the deployment package 612 may be communicated to the client 604 with the multiplatform messages 606.

The client 604 may include a workspace 614 for loading parts of the deployment package 612. For example, the workspace 614 may be a reserved area of memory 106 (FIG. 1). Presentation specification 326 (FIG. 3) parts of the deployment package 612 may be rendered at a client graphical user interface (GUI) 616. The client 604 may include a client language module 618 for executing a particular programming language such as ECMAScript. The client 604 may further include a client domain module 620 providing structured access to client functionality such as client GUI 616 functionality. The client domain module 620 may provide access to client functionality through an application programming interface (API) compatible with the programming language executable by the client language module 618.

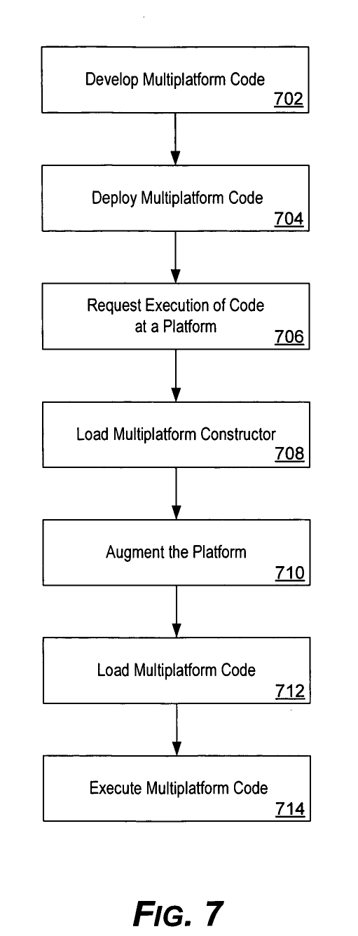

Multiplatform code 320 (FIG. 3), multiplatform component library 322 components and/or multiplatform constructor 324 parts of the deployment package 612 may be executed by the client 604. For example, the executable parts 320, 322 and 324 of the deployment package 612 may be loaded into the workspace 614 and executed in accordance with the client language module 618. FIG. 7 depicts, at a high level, example steps for executing multiplatform code 320 in accordance with an embodiment of the invention.

At step 702, multiplatform code may be developed, for example, the multiplatform code 320 (FIG. 3) may be developed with the multiplatform code development environment 302. Example steps for multiplatform code development are described in more detail below with reference to FIGS. 8, 9, 10, 11 and 12. At step 704, the multiplatform code may be deployed. For example, the deployment package 306 may be created by the multiplatform code development environment 302 and the presentation development environment 304. The deployment package 306 may be deployed as specified by the deployment location specification(s) 416 (FIG. 4), for example, to the server 308.

At step 706, a particular platform may request execution of the multiplatform code. For example, the client 604 (FIG. 6) may request one or more units of the presentation specification 326 (FIG. 3) for rendering to the client GUI 616. One or more particular units of the presentation specification 326 may reference the multiplatform constructor 324 and/or multiplatform code 320 functionality. For example, the contract(s) 318 associated with the requested presentation specification 326 unit(s) may specify multiplatform code 320 functionality, and the multiplatform constructor 324 may correspond to the contract(s) 318.

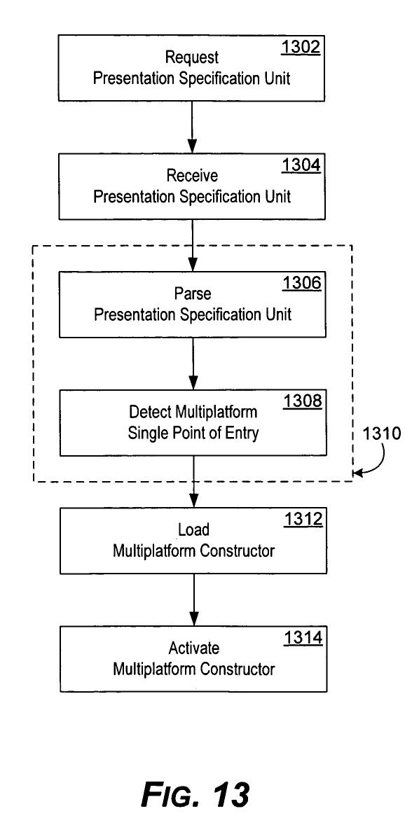

At step 708, the multiplatform constructor 324 (FIG. 3) referenced by the presentation specification 326 unit(s) and/or associated with multiplatform code 320 functionality referenced by the presentation specification 326 unit(s) may be loaded by the client 604 (FIG. 6). For example, the multiplatform constructor 324 may be loaded in the workspace 614 and activated. Steps 706 and 708 are described below in more detail with reference to FIG. 13.

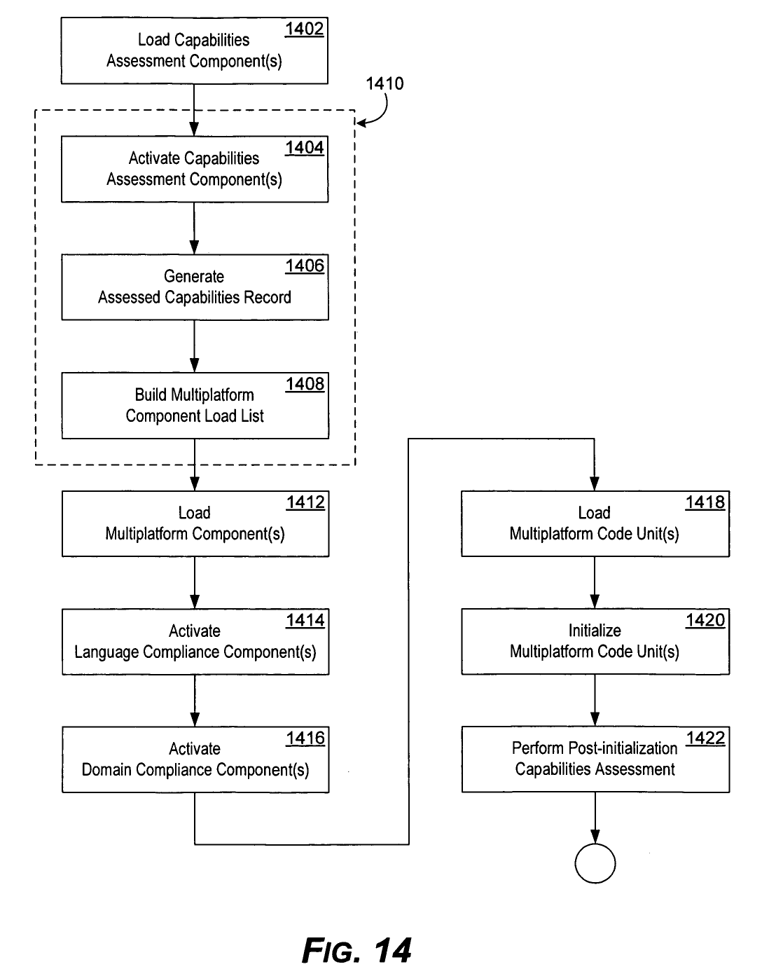

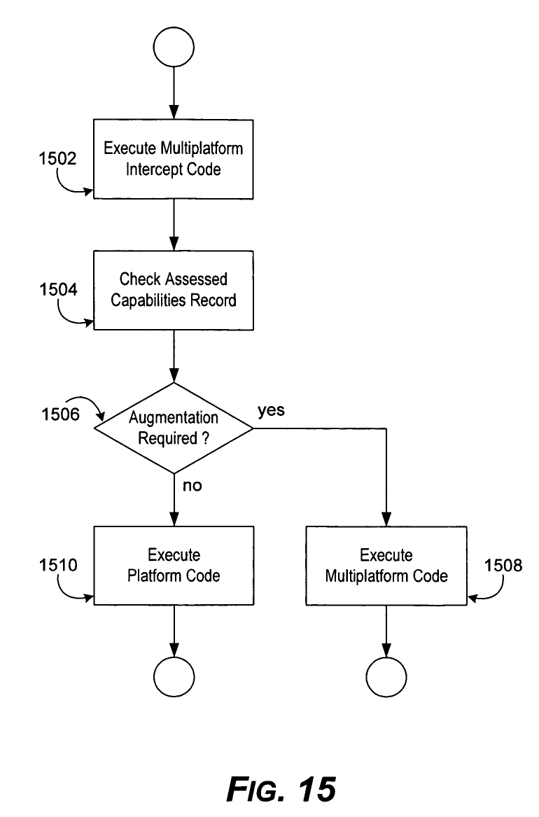

At step 710, the requesting platform may be augmented. For example, the multiplatform constructor 324 (FIG. 3) may load components of the multiplatform component library 322 to assess and augment the client 604 (FIG. 6) to comply with the domain specification(s) 408 (FIG. 4). At step 712, the multiplatform code may be loaded. For example, the multiplatform code 320 may be loaded into the workspace 614 of the augmented client 604. At step 714, the multiplatform code may be executed. For example, the client 604 may execute the multiplatform code 320 loaded into the workspace 614. In an embodiment of the invention, the client 604 includes a markup language browser, the multiplatform code 320 includes translated ECMAScript, and, after the multiplatform code 320 is loaded into the augmented client 604, sections of multiplatform code 320 are executed in response to client 604 user generated events such as client GUI 616 events. Steps 710, 712 and 714 are described below in more detail with reference to FIGS. 14 and 15.

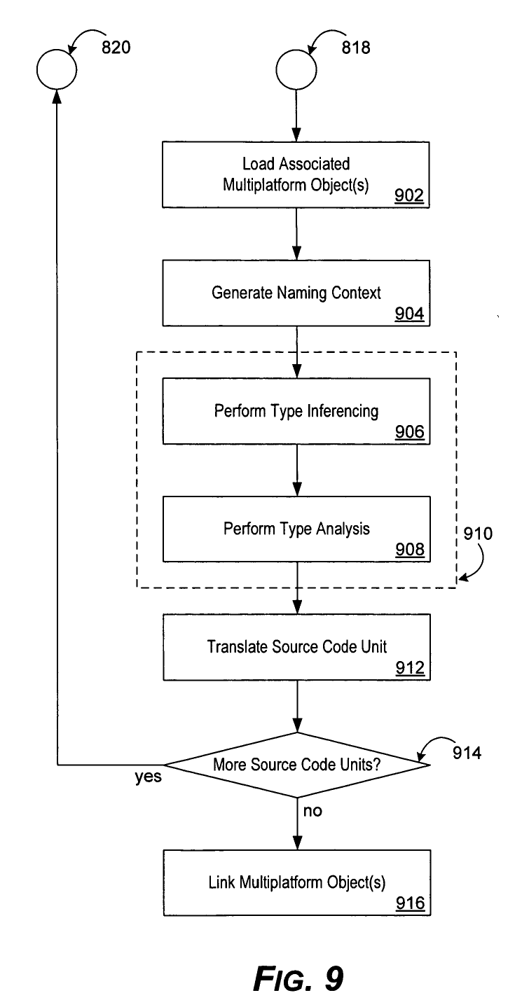

FIGS. 8 and 9 depict example steps for developing multiplatform code in accordance with an embodiment of the invention. At step 802, one or more domain specifications may be selected. For example, the multiplatform object generator 402 (FIG. 4) may select the domain specification(s) 408. In an embodiment of the invention, the selection of the multiplatform object generator 402 corresponds to a selection at the multiplatform code development GUI 418 by a user of the multiplatform code development environment 400. At step 804, the selected domain specification(s) may be parsed, for example, by the domain specification parser 426.

At step 806, a set of source code may be selected. For example, the multiplatform object generator 402 (FIG. 4) may select one or more units of the source code 406. In an embodiment of the invention, units of the source code 406 correspond to text files containing one or more lines of the ECMAScript programming language. Source code 406 units may be grouped, for example, into libraries, applications or projects, and groups of source code 406 units may be selected instead of individual source code 406 units. The selection of the multiplatform object generator 402 may correspond to a selection at the multiplatform code development GUI 418 by the user of the multiplatform code development environment 400.

Some of the units of the set of source code may depend upon one another. For example, a particular unit of the source code set may invoke functionality specified by a different unit of the source code set. At step 808, dependencies among units of the set of source code may be specified. For example, each unit of the set of source code may be associated with a dependency list of zero or more source code 406 (FIG. 4) units. Dependencies may be specified with the multiplatform code development GUI 418, command line parameters, a configuration file and/or any suitable dependency specification mechanism. In an embodiment of the invention, steps 806 and 808 are integral to a single step indicated in FIG. 8 by dashed line 810.

At step 812, a first (or next) source code unit may be selected from the set. At step 814, the selected source code unit may be parsed. For example, a selected unit of the source code 406 (FIG. 4) may be parsed by the source code parser 420 to generate and/or update the abstract syntax tree 422. The abstract syntax tree 422 may correspond to the selected source code unit in a manner well understood by those of skill in the art. Syntax anomalies may be reported, for example, to the multiplatform code development GUI 418. Anomalies may be graded according to severity, and the procedure may be aborted if an anomaly occurs that has a severity grade above a user configured severity threshold.

At step 816, an execution flow analysis of programming language instructions in the selected source code unit may be performed. For example, the flow analyzer 431 (FIG. 4) may traverse the abstract syntax tree 422 to determine a presence of dead code in the corresponding source code 406 unit and other suitable execution flow anomalies. As for step 814, anomalies may be reported to the multiplatform code development GUI 418, and the procedure aborted for a sufficiently severe anomaly. The flowchart connectors 818 and 820 correspond to like numbered connectors of FIG. 9.

It may be that the selected source code 406 unit is dependent on one or more of the multiplatform objects 404, for example, one or more of the multiplatform code units 440 previously translated by the multiplatform translator 438 that correspond to source code 406 unit(s) specified in the dependency list of the selected source code 406 unit. Comprehensive unit anomaly auditing, in particular, type anomaly auditing, may require information from the associated multiplatform object(s) 404. At step 902, multiplatform object(s) 404 associated with the source code 406 unit may be loaded into the multiplatform object generator 402. For example, associated unit type verificand(s) 442 may be loaded into the type verificand 436, and associated unit naming context(s) 444 may be loaded into the naming context 432. Inability to load associated multiplatform object(s) 404 may warrant reporting and procedure abort.

At step 904, naming context for the selected source code unit may be generated. For example, the naming context generator 430 (FIG. 4) may traverse the abstract syntax tree 422 and/or the domain specification object(s) 428 to create and/or update the naming context 432. Lexical scoping anomalies and/or ambiguities may be reported to the multiplatform code development GUI 418, and the procedure may be aborted for a sufficiently severe anomaly.

At step 906, types of source code unit objects may be inferred. For example, the type inferencing engine 434 (FIG. 4) may create, update and/or resolve the type verificand 436 with type relationships in the abstract syntax tree 422 and in light of the naming context 432 and/or attributes of the domain specification object(s) 428. At step 908, an analysis of the inferred types may be performed. For example, the type inferencing engine 434 may check the resolved type verificand 436 for type mismatch and other object type anomalies. Anomalies may be reported, for example, to the multiplatform code development GUI 418, and the procedure aborted in the case of a sufficiently severe anomaly. In an embodiment of the invention, steps 906 and 908 are integral to a single step indicated in FIG. 9 by dashed line 910. For example, the type analysis of step 908 may occur as an integral part of type inferencing.

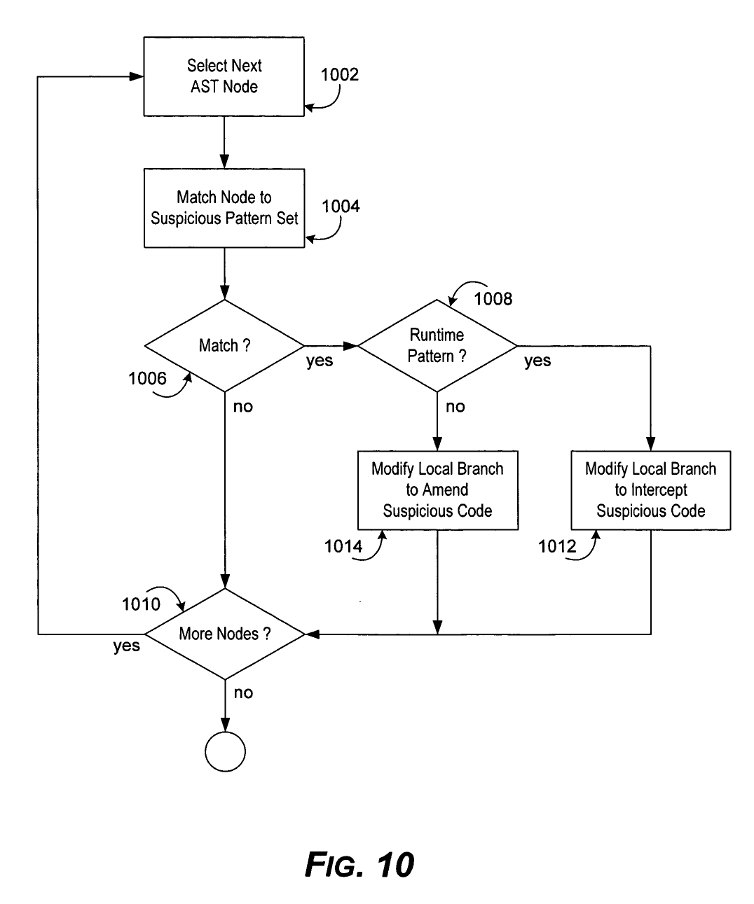

At step 912, the selected source code unit may be translated into a corresponding multiplatform object. For example, units of the source code 406 (FIG. 4) may be translated to multiplatform code unit(s) 440 by the multiplatform translator 438. It may be that anomalies arise during translation, and such anomalies may be reported, for example, to the multiplatform code development GUI 418. If a severity of the translation anomaly is sufficient, the procedure may be aborted. Example steps for translating source code to multiplatform code are described below in more detail with reference to FIG. 10.

At step 914, it may be determined if there are more source code units in the selected source code set. If there are more source code units, then the procedure may return to step 812 (FIG. 8) to select the next source code unit for processing. Otherwise, the procedure may progress to step 916.

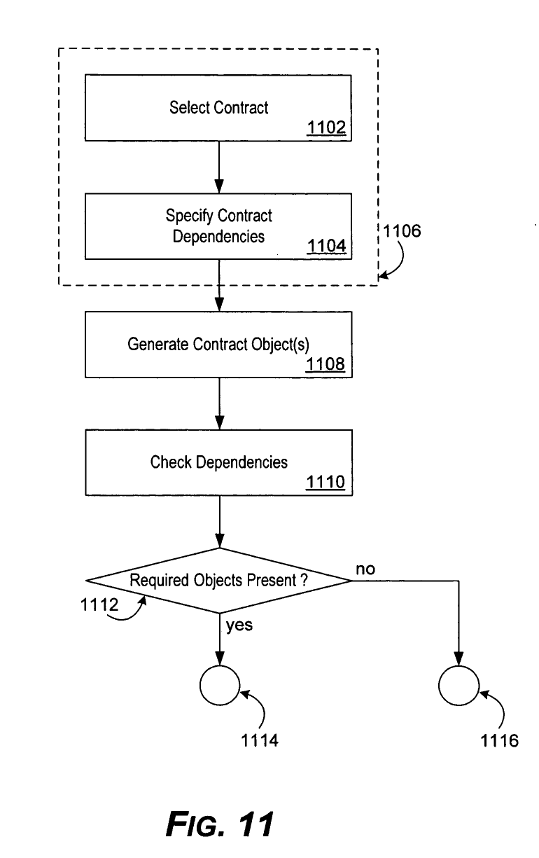

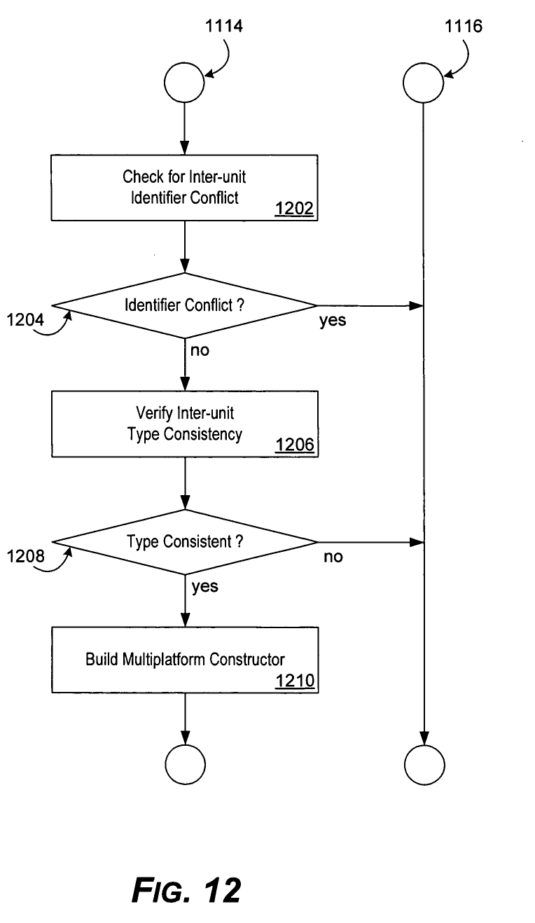

At step 916, the multiplatform code objects may be linked. For example, the multiplatform object(s) 404 (FIG. 4) may be linked by the multiplatform object linker 410 in accordance with the contract(s) 414 and the deployment location specification(s) 416 to create and/or update the deployment package 412. During linking, link anomalies may arise, and such anomalies may be reported, for example, to the multiplatform code development GUI 418. Anomalies with a severity greater than the user configurable severity threshold may cause the procedure to abort. Example steps for linking multiplatform objects are described below in more detail with reference to FIGS. 11 and 12.

FIG. 10 depicts example steps for translating to multiplatform code in accordance with an embodiment of the invention. For example, the steps depicted in FIG. 10 may be performed by the multiplatform translator 438 (FIG. 4). At step 1002, a first (or next) abstract syntax tree node may be selected, for example, during a traversal of the abstract syntax tree 422 corresponding to one or more units of the source code 406.

At step 1004, the selected node may be matched to a suspicious pattern set. For example, the suspicious pattern set may specify one or more patterns or filters corresponding to programming language statements or parts of programming language statements that are potentially platform specific and/or non-compliant with the domain specification(s) 408 (FIG. 4). The selected node and possibly one or more of its child nodes and/or parent nodes in the abstract syntax tree 422 may be compared with each pattern in the suspicious pattern set to find a match. Some or all patterns in the suspicious pattern set may require associated naming context 432 and/or type verificand 436 information in order to carry out the comparison. As will be appreciated by one of skill in the art, patterns in the suspicious pattern set may be aggregated for efficient matching.

At step 1006, it may be determined if the selected node matched a particular pattern in the suspicious pattern set. If the node did match a particular pattern, the procedure may progress to step 1008. Otherwise, the procedure may progress to step 1010.

Some platform specific and/or domain specification 408 (FIG. 4) non-compliant structure and/or behavior may be amended at translation-time. In other cases, modifications may be required at execution-time or runtime. For example, capabilities assessment may be required before making a modification decision. Accordingly, each pattern in the suspicious pattern set may be classified as a translation-time pattern or a runtime pattern. Each translation-time pattern may correspond to structure and/or behavior that may be amended at translation-time. Each runtime pattern may correspond to structure and/or behavior that may require runtime modification. At step 1008, it may be determined if the matching pattern is a runtime pattern. If the matching pattern is a runtime pattern, the procedure may progress to step 1012. Otherwise, the procedure may progress to step 1014.

Each runtime pattern in the suspicious pattern set may be associated with multiplatform intercept code. At step 1012, a local branch of the abstract syntax tree 422 (FIG. 4) containing the selected node may be modified to intercept code corresponding to the matching runtime pattern. For example, the local branch may be modified to incorporate the multiplatform intercept code associated with the matching suspicious pattern. In modifying the local branch, the functionality of the unmodified code need not be lost. A reference to the unmodified code may be preserved, so that the unmodified code may be later executed, for example, in the case that the runtime modification decision is that runtime modification is not required. For example, a local branch corresponding to a platform-specific function “f(a,b)” may be modified to correspond to a multiplatform function “multi_f (a,b)” and the multiplatform function may call the platform-specific function for a particular value of a capabilities assessment result in the assessed capabilities record 512 (FIG. 5).

Each translation-time pattern in the suspicious pattern set may be associated with a multiplatform translation action. At step 1014, a local branch of the abstract syntax tree 422 (FIG. 4) containing the selected node may be amended in accordance with the multiplatform translation action associated with the matching translation-time pattern. Examples of multiplatform translation actions include syntax amendments, canonicalization of data structures, references to data structures, and/or function call specifications such as parameter number and/or order, replacement or rewriting of platform-specific and/or non-compliant function calls with corresponding multiplatform function calls, additions of compliance enforcement function calls and/or function call wrappers, and any suitable abstract syntax tree 422 amendment.

An example of a particular ECMAScript translation-time pattern and multiplatform translation action is detection of and substitution for named function literals. The named function literals feature of ECMAScript allows naming of a function for reference within that function, for example, when implementing a recursive function. However, some platforms don't properly support named function literals, resulting in possible application instability. In an embodiment of the invention, the troublesome function name may be deleted and a substitute variable instantiated and initialized to play an equivalent role. A code fragment will illustrate:

var f = function fact(n) {

if (n == 0) return 1;
return n * fact(n−1);

}

The named function literal ‘fact’ is utilized to recursively implement the familiar factorial function. At step 1014, the local branch of the abstract syntax tree 422 (FIG. 4) corresponding to the above code fragment may be amended to correspond to the following substitute code fragment:

var f = function(n) {

var fact = arguments.callee;
if (n == 0) return 1;
return n * fact(n−1);

}

In the substitute code fragment, the named function literal is gone. In its place, a variable with the same name ‘fact’ is instantiated and initialized so that the expression “fact(n−1)” recursively invokes the function as in the original code fragment but without the platform-specific named function literal feature.

At step 1010, it may be determined if there are further abstract syntax tree nodes requiring traversal. If there are remaining nodes, the procedure may return to step 1002 to select the next abstract syntax tree node. Otherwise, this procedure for translating to multiplatform code may progress, for example, to step 912 of FIG. 9.

FIGS. 11 and 12 depict example steps for linking multiplatform objects in accordance with an embodiment of the invention. For example, the steps depicted in FIGS. 11 and 12 may be performed by the multiplatform object linker 410 (FIG. 4). At step 1102, a contract may be selected. For example, the multiplatform object linker 410 may select one of the contracts 414. The multiplatform object linker 410 selection may correspond to a graphical selection at the multiplatform code development GUI 418 by a user of the multiplatform code development environment 400. The selected contract may reference one or more of the multiplatform object(s) 404. For example, the selected contract may reference functionality provided by the multiplatform object(s) 404.

At step 1104, one or more contract dependencies may be specified. For example, the selected contract may have one or more dependencies on functionality provided by the multiplatform object(s) 404 (FIG. 4). As for step 808 (FIG. 8), dependencies may be specified with the multiplatform code development GUI 418, command line parameters, a configuration file and/or any suitable dependency specification mechanism. In an embodiment of the invention, steps 1102 and 1104 are integral to a single step indicated in FIG. 11 by dashed line 1106.

At step 1108, one or more contract objects 448 (FIG. 4) corresponding to the selected contract may be generated, for example, by the contract object generator 446 as described above with reference to FIG. 4. At step 1110, dependencies among the contract object(s) 448 and the multiplatform object(s) 404 may be checked. For example, the multiplatform object linker 410 may check each of the contract dependencies specified at step 1104. At step 1112, it may be determined if each of the required multiplatform objects 404 is present. If each required multiplatform object 404 is present, the procedure may progress to step 1202 of FIG. 12. Otherwise, a missing object anomaly has been detected and the procedure may exit. The missing object anomaly may be reported, for example, to the multiplatform code development GUI 418. The flowchart connectors 1114 and 1116 correspond to like numbered connectors of FIG. 12. The procedural path connected by flowchart connector 1116 is an exit path.

At step 1202, an inter-unit identifier conflict check may be performed. For example, the unit naming context(s) 444 (FIG. 4) associated with each specified multiplatform object 404 may be combined and cross-checked for conflicts and/or inconsistencies. In addition, naming context information associated with the contract(s) 414 and/or the domain specification(s) 408 may be further combined and further cross-checked for conflicts and/or inconsistencies. In an embodiment of the invention, cross-checked naming context includes identifiers of global scope. Naming context associated with the contract(s) 414 and/or the domain specification(s) 408 may include global scope identifiers that are programmatically reserved, that is, not available for utilization by application developers. At step 1204, it may be determined if an inter-unit identifier conflict has occurred. If an inter-unit identifier conflict has occurred, the anomaly may be reported, for example, to the multiplatform code development GUI 418, and the procedure may exit. Otherwise, the procedure may progress to step 1206.

Just as the type inferencing engine 434 (FIG. 4) may verify type consistency across source code 406 units, the multiplatform object linker 410 may verify type consistency across multiplatform code unit(s) 440. At step 1206, inter-unit type consistency may be verified. For example, the type-awareness module 450 may resolve unit type verificand(s) 442 corresponding to specified multiplatform code unit(s) 440 and/or multiplatform object(s) 404. In addition, unit type verificands associated with the contract(s) 414 and/or the domain specification(s) 408 may be incorporated into the set of unit type verificands to be resolved. The type-awareness module 450 may utilize the type inferencing engine 434 or a version thereof to resolve the set of unit type verificands. At step 1208, it may be determined if inter-unit type consistency has been verified. If an inter-unit type inconsistency has been found, the anomaly may be reported, for example, to the multiplatform code development GUI 418, and the procedure may exit. Otherwise, the procedure may progress to step 1210.

At step 1210, a multiplatform constructor may be built. For example, the multiplatform constructor factory 452 (FIG. 4) may instantiate the multiplatform constructor 324 (FIG. 3) corresponding to the selected contract. In an embodiment of the invention, the multiplatform constructor 324 is capable of loading multiplatform component library 322 components at the client 604 (FIG. 6) to assess and possibly augment the client 604, as well as loading multiplatform code 320 units corresponding to the selected contract. Example steps performed by the multiplatform constructor in accordance with an embodiment of the invention are described below in more detail with reference to FIG. 14.

In an embodiment of the invention, the multiplatform constructor 324 (FIG. 3) enables a single point of entry for platform augmentation. For example, in the case that the presentation specification 326 includes HTML, a single statement of ECMAScript embedded in the presentation specification 326 may serve as the single point of entry for the multiplatform constructor 324 and HTML client augmentation. FIG. 13 depicts example steps for single point of entry platform augmentation in accordance with an embodiment of the invention.

At step 1302, a unit of the presentation specification 326 (FIG. 3) may be requested. For example, the client 604 (FIG. 6) may be an HTML client, the server 602 may be an HTML server, and the units of the presentation specification 326 contained in the deployment package 612 may be HTML files. The client 604 may request a particular HTML file from the server 602. At step 1304, the unit of the presentation specification 326 may be received. For example, the client 604 may receive the requested HTML file from the server 602.

At step 1306, the unit of the presentation specification 326 may be parsed. For example, the client 604 (FIG. 6) may parse the received HTML file with a conventional HTML parser (not shown in FIG. 6). At step 1308, the multiplatform single point of entry may be detected. In an embodiment of the invention, steps 1306 and 1308 are integral to a single step indicated in FIG. 13 by dashed line 1310. For example, the received HTML file may contain a statement of ECMAScript located within an HTML “script” element and the statement may be detected during parsing of the HTML file.

The ECMAScript statement may correspond to instructions to load the multiplatform constructor 324 (FIG. 3) and, at step 1312, the multiplatform constructor 324 may be loaded. For example, in response to the ECMAScript statement, the client 604 (FIG. 6) may request the multiplatform constructor 324 from the deployment package 612 at the server 602. The server 602 may provide the multiplatform constructor 324 to the client 604, and the client may load the multiplatform constructor 324 in the workspace 614. At step 1314, the loaded multiplatform constructor 324 may be activated. Results of multiplatform constructor 324 activation are described below in more detail with reference to FIG. 14.

FIG. 14 depicts example steps performed by a multiplatform constructor in accordance with an embodiment of the invention. At step 1402, one or more capabilities assessment components may be loaded. Continuing the example described above with reference to FIG. 13, the client 604 (FIG. 6) may be instructed by the loaded multiplatform constructor 324 (FIG. 3) to load one or more of the capabilities assessment components 504 (FIG. 5) contained in the deployment package 612 at the server 602. The client 604 may request the capabilities assessment components 504 with one or more multiplatform messages 606, and the server may provide the requested components 504 with one or more multiplatform messages 606. The client 604 may load the received capabilities assessment components 504 into the workspace 614, and, at step 1404, the loaded capabilities assessment components 504 may be activated.

The activated capabilities assessment components 504 (FIG. 5) may assess the capabilities of the client 604 (FIG. 6), for example, with respect to the domain specification(s) 408 (FIG. 4), and, at step 1406, the assessed capabilities record 512 may be generated. For example, the client language module 618 may include ECMAScript base objects and the client platform module 620 may include objects corresponding to a domain object model (DOM) for the client 604. Capabilities assessment components 504 may include ECMAScript code that probes the structure and/or behavior of the client language module 618 and/or the client domain module 620.

For example, capabilities assessment components 504 (FIG. 5) may utilize an “is defined” operation to probe for the presence or non-presence of programmatic objects, object attributes and/or object methods in the client language module 618 (FIG. 6) and/or the client domain module 620. In ECMAScript, the “is defined” operation may be implemented with the “typeof” operator testing whether the “typeof” operator returns the value “undefined” when applied to a particular programmatic object. Capabilities assessment components 504 may utilize the ECMAScript “try . . . catch” feature to probe module 618, 620 behavior that may raise programmatic exceptions. Capabilities assessment components 504 may set alarms that trigger probes at some later time. Probe results may be recorded in the assessed capabilities record 512.

At step 1408, a multiplatform component load list may be built. For example, for each entry in the assessed capabilities record 512 (FIG. 5), zero or more components of the multiplatform library 502 may be added to the multiplatform component load list as indicated by the capability-compliance map 514. In an embodiment of the invention, steps 1404, 1406 and 1408 are integral to a single step indicated in FIG. 14 by dashed line 1410.

At step 1412, the multiplatform components in the multiplatform component load list may be loaded. For example, for each multiplatform component referenced by the multiplatform component load list, the client 604 (FIG. 6) may be instructed by the activated multiplatform constructor 324 (FIG. 3) to load the multiplatform component from the multiplatform component library 322 contained in the deployment package 612. The client 604 may request each multiplatform component with one or more multiplatform messages 606, and the server 603 may provide each requested component with one or more multiplatform messages 606. The client 604 may load each received multiplatform component into the workspace 614.

At step .1414, the loaded language compliance component(s) 506 (FIG. 5), if any, may be activated. For example, the activated language compliance component(s) 506 may augment the client language module 618 (FIG. 6). The activated language compliance component(s) 506 may update and/or replace components of the client language module 618. The activated language compliance component(s) 506 may provide for selective augmentation as described below with reference to FIG. 15.

Similarly, at step 1416, loaded domain compliance component(s) 508, 510 (FIG. 5), if any, may be activated. For example, the activated domain compliance component(s) 508, 510 may augment the client domain module 620 (FIG. 6). The activated domain compliance component(s) 508, 510 may update and/or replace components of the client domain module 620. The activated domain compliance component(s) 508, 510 may provide for selective augmentation as described below with reference to FIG. 15.

At step 1418, the multiplatform code 320 (FIG. 3) unit(s) referenced by the multiplatform constructor 324 may be loaded. For example, for each multiplatform code 320 unit referenced by the multiplatform constructor 324, the client 604 (FIG. 6) may be instructed by the activated multiplatform constructor 324 to load the multiplatform code 320 unit from the deployment package 612. The client 604 may request each multiplatform code 320 unit with one or more multiplatform messages 606, and the server may provide each requested code 320 unit with one or more multiplatform messages 606. The client 604 may load each received multiplatform code 320 unit into the workspace 614.

At step 1420, the loaded multiplatform code 320 (FIG. 3) unit(s) may be initialized. For example, the multiplatform code 320 (FIG. 3) unit(s) may be initialized as part of conventional client language module 618 (FIG. 6) and/or client domain module 620 initialization following execution of the ECMAScript statement associated with the multiplatform single point of entry. Some capabilities assessment may be postponed until after initialization is complete. At step 1422, any such post-initialization capabilities assessment may be performed, for example, by loaded capabilities assessment components 504 (FIG. 5). In particular, probes triggered by alarms may occur at step 1422.

Following initialization, the loaded multiplatform code 320 (FIG. 3) unit(s) may be executed, for example, in response to client 604 (FIG. 6) user interaction with the client GUI 616. FIG. 15 depict example steps for selective augmentation in accordance with an embodiment of the invention. At step 1502, multiplatform intercept code may be executed. For example, the loaded multiplatform code 320 unit(s) may have been modified to include the multiplatform intercept code at step 1012 of FIG. 10.

At step 1504, the assessed capabilities record 512 (FIG. 5) may be checked. At step 1506, it may be determined if augmentation is required. For example, the augmentation decision may be predicated on one or more capabilities assessment results. If it is determined that augmentation is required, the procedure may progress to step 1508. Otherwise the procedure may progress to step 1510.

At step 1508, multiplatform code may be executed. For example, the loaded multiplatform code 320 (FIG. 3) unit including the multiplatform intercept code may continue to be executed. At step 1510, platform code may be executed. For example, the loaded multiplatform code 320 unit including the multiplatform intercept code may pass through execution to code in the client language module 618 (FIG. 6) and/or the client domain module 620.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. At least one computer-readable medium having thereon computer-executable instructions for developing multiplatform code comprising:
selecting at least one domain specification;
selecting at least one source code unit; and
translating said at least one source code unit into at least one multiplatform code unit in accordance with said at least one domain specification.

2. Said at least one computer-readable medium of claim 1, wherein:
said at least one source code unit comprises at least one statement of a programming language; and
said at least one multiplatform code unit comprises at least one statement of the programming language.

3. Said at least one computer-readable medium of claim 1, wherein said at least one source code unit comprises at least one statement of an interpreted programming language.

4. Said at least one computer-readable medium of claim 1, wherein:
said at least one source code unit comprises at least one statement of a programming language; and
translating said at least one source code unit comprises matching said at least one statement to a suspicious pattern set.

5. Said at least one computer-readable medium of claim 1, wherein:
said at least one source code unit comprises at least one statement of a programming language; and
translating said at least one source code unit comprises amending said at least one statement.

6. Said at least one computer-readable medium of claim 1, wherein:
said at least one source code unit comprises at least one statement of a programming language; and
translating said at least one source code unit comprises arranging for intercept of said at least one statement.

7. Said at least one computer-readable medium of claim 1, wherein:
the computer-executable instructions further comprise creating an abstract syntax tree corresponding to said at least one source code unit; and
translating said at least one source code unit comprises modifying the abstract syntax tree.

8. At least one computer-readable medium having thereon computer-executable instructions for linking multiplatform objects comprising:
specifying a set of multiplatform objects to be linked;
checking type consistency across the set of multiplatform objects; and
linking each multiplatform object in the set of multiplatform objects if the set of multiplatform objects is type consistent.

9. Said at least one computer-readable medium of claim 8, wherein each multiplatform object in the set of multiplatform objects comprises a multiplatform code unit and a unit type verificand for the multiplatform code unit.

10. Said at least one computer-readable medium of claim 9, wherein checking type consistency across the set of multiplatform objects comprises resolving the set of unit type verificands contained in the set of multiplatform objects.

11. Said at least one computer-readable medium of claim 9, wherein:
the computer-executable instructions further comprise:
selecting a programmatic contract referencing at least one multiplatform object in the set of multiplatform objects; and
generating, from the programmatic contract, a contract object comprising a unit type verificand; and
checking type consistency across the set of multiplatform objects comprises resolving the set of unit type verificands contained in the set of multiplatform objects together with the unit type verificand contained in the contract object.

12. Said at least one computer-readable medium of claim 9, wherein the multiplatform code unit comprises at least one statement of an interpreted programming language.

13. Said at least one computer-readable medium of claim 8, wherein the computer-executable instructions further comprise selecting a programmatic contract referencing at least one multiplatform object in the set of multiplatform objects.

14. At least one computer-readable medium having thereon computer-executable instructions for augmenting a platform to a multiplatform standard comprising:
loading at least one capabilities assessment component;
generating an assessed capabilities record at least in part with said at least one capabilities assessment component; and
loading at least one multiplatform component in accordance with the assessed capabilities record.

15. Said at least one computer-readable medium of claim 14, wherein loading said at least one multiplatform component in accordance with the assessed capabilities record comprises loading each multiplatform component as indicated by a capability-compliance map.

16. Said at least one computer-readable medium of claim 14, wherein said at least one capabilities assessment component comprises at least one language compliance component and at least one domain compliance component.

17. Said at least one computer-readable medium of claim 14, wherein said at least one capabilities assessment component comprises a plurality of domain compliance components graded according to a plurality of domain compliance levels.

18. Said at least one computer-readable medium of claim 14, wherein the computer-executable instructions further comprise:
parsing a unit of a presentation specification;
detecting a multiplatform single point of entry in the unit of the presentation specification, the multiplatform single point of entry referencing a multiplatform constructor, the multiplatform constructor referencing each capabilities assessment component; and
loading the multiplatform constructor.

19. Said at least one computer-readable medium of claim 18, wherein the computer-executable instructions further comprise building the multiplatform constructor in accordance with a programmatic contract.

20. Said at least one computer-readable medium of claim 18, wherein the presentation specification comprises at least one element of a markup language.
